(19) United States
(12) Patent Application Publication
(10) Pub. No.: US 2017/0180758 A1
(43) Pub. Date: Jun. 22, 2017

(54) Tiled Wireless Display

(71) Applicants: Vallabhajosyula S. Somayazulu, Portland, OR (US); Yiting Liao, Hillsboro, OR (US); Paul S. Diefenbaugh, Portland, OR (US); Krishnan Rajamani, San Diego, CA (US); Kristoffer D. Fleming, Chandler, AZ (US)

(72) Inventors: Vallabhajosyula S. Somayazulu, Portland, OR (US); Yiting Liao, Hillsboro, OR (US); Paul S. Diefenbaugh, Portland, OR (US); Krishnan Rajamani, San Diego, CA (US); Kristoffer D. Fleming, Chandler, AZ (US)

(21) Appl. No.: 14/978,017

(22) Filed: Dec. 22, 2015

(51) Int. Cl. H04N 19/96; H04N 19/17

(52) U.S. Cl. CPC H04N 19/96; H04N 19/17

(57) ABSTRACT

A tile concept allows independent encoding and decoding of regions of the video frames combined with changes in the way that the coded tiles are packetized and queued for transport. After the coded tile network abstraction layer (NAL) units are packetized into MPEG-TS frames, the more important tile data is put in the network abstraction layer at the head of the queue while the less important data is inserted later in the queue. Audio can also be accorded high priority. For a given link bandwidth/latency environment, the important data is transmitted first and the less important data can be discarded at the transmitter with less impact on the user perceived quality.

### BACKGROUND

A wireless display displays data that it receives wirelessly for example using a Realtime Transfer Protocol (RTP) transport and H.264 compression. RTP is an Internet protocol standard for managing real-time transmission of multimedia data over unicast or multicast network services. H.264 compression is a video coding format for block-oriented motion-compensation based video compression according to a standard called H.264/AVC maintained by the Joint Video Team of the ITU-T. An MPEG2 transport stream is a standard container format for transmission and storing of video and audio. See ISO/IEC Standard 13818-1.

In wireless display systems using H.264 based compression and MPEG2 transport stream (TS) over real-time transport protocol (RTP) transport, there is no means of differentiating between different regions of a picture from an error resiliency point of view. Region of interest coding can be used for optimizing the picture rate-distortion tradeoff in terms of bit allocation, but not really for unequal error protection or error resiliency.

Thus, once a video frame(s) has been encoded, all of it (or the whole slice) must be received at the decoder or else decode failure will occur and the error will have to be concealed. In particular, when encoding typical desktop content, the screen contains different regions with different types of content (e.g. full motion video, productivity content, gaming, etc.) which must all be coded and transported together as a single unit. This results in a poor user quality of experience when wireless link bandwidth is varying or when link errors occur.

### BRIEF DESCRIPTION OF THE DRAWINGS

Some embodiments are described with respect to the following figures:

FIG. 1 is a depiction of an example of a picture divided into nine tiles according to one embodiment;

FIG. 2 is a depiction of dividing a picture into ROI and non-ROI files according to one embodiment;

FIG. 3 is a depiction of prioritizing updated regions to reduce perceived perceptual latency according to one embodiment;

FIG. 4 is a flow chart for one embodiment;

FIG. 5 is a schematic depiction of a transmitter according to one embodiment; and

FIG. 6 is a schematic depiction of a pair of devices arranged as transmitter and receiver according to one embodiment.

### DETAILED DESCRIPTION

A tile concept allows independent encoding and decoding of regions of the video frames combined with changes in the way that the coded tiles are packetized and queued for transport. After the coded tile network abstraction layer (NAL) units are packetized into MPEG-TS frames, the more important tile data is put in the network abstraction layer at the head of the queue while the less important data is inserted later in the queue. Audio can also be accorded high priority. For a given link bandwidth/latency environment, the important data is transmitted first and the less important data can be discarded at the transmitter with less impact on the user perceived quality.

The High Efficiency Video Coding (HEVC) standard is joint video project of the ITU-T Video Coding Experts Group (VCEG) and the ISO.IEC Moving Picture Experts Group (MPEG) standardization organizations, working together in a partnership known as the Joint Collaborative Team on Video Coding (JCT-VC). HEVC has been designed to address essentially all existing applications of H.264/MPEG-4 AVC and to particularly focus on two key issues: increased video resolution and increased use of parallel processing architectures.

In HEVC, a picture is partitioned into coding tree units (CTUs), which are the basic processing units in the standard. Furthermore, each picture may be partitioned into rows and columns of CTUs. A tile is the rectangular region of CTUs based on the horizontal and vertical boundaries of the CTU rows and columns.

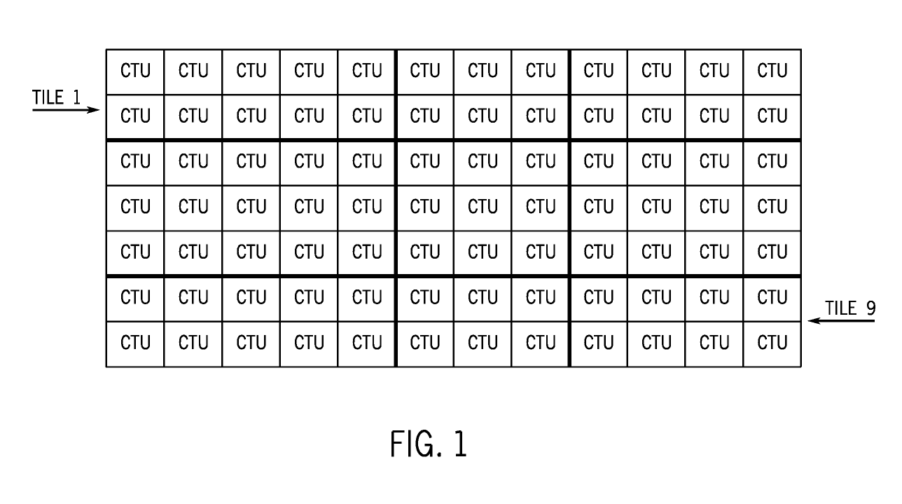

FIG. 1 shows an example of a picture arbitrarily being divided into nine tiles. A tile has these basic attributes: (1) a tile is always aligned with CTU boundaries; (2) the CTUs within a tile are processed in a raster scan order; and (3) tiles break in-picture prediction dependencies as well as entropy decoding dependencies. Tiles divide the frame into a grid of rectangular regions that can independently be decoded/encoded. In other words, when doing intra encoding, the current tile cannot use pixels that across a tile boundary for prediction. Also there is no dependency in entropy coding across a tile boundary. As a result, a decoder can process tiles in parallel with other tiles. Therefore tiles enable parallel processing of encoding and decoding as long as the shared header information of multiple tiles is provided.

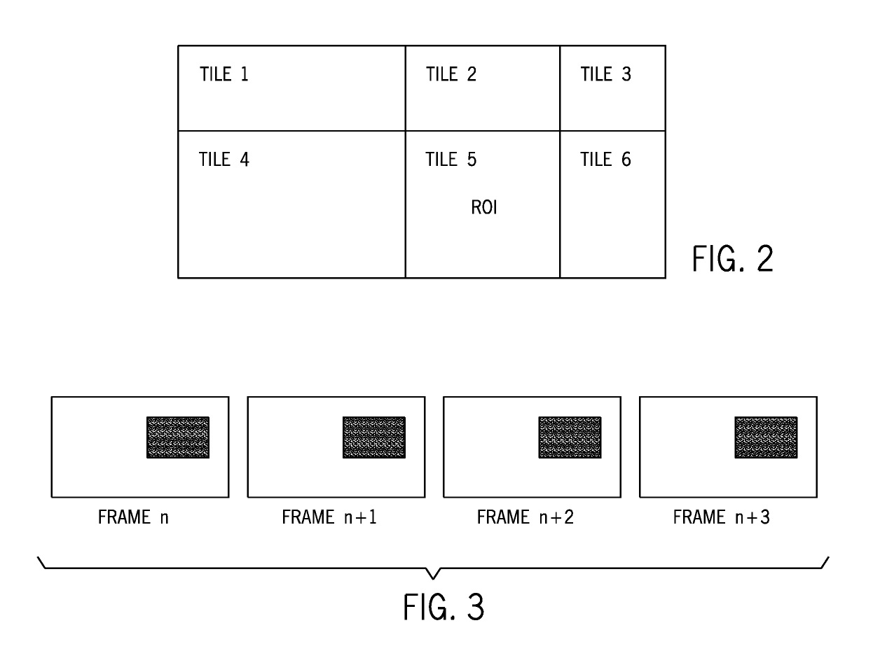

The encoding may be based on Region of Interest (ROI) for quality enhancement in a wireless display system. Dirty rectangle information generated from a region update agent can be fed into the encoder. Dirty rectangle information is a portion of a buffer than has been changed and must be updated. Based on this dirty information, the encoder can divide a picture into non-ROI and ROI tiles (as shown in FIG. 2). A dirty rectangle indicates the region has graphic updating (is changing). The encoder assumes that the current ROI is the “dirty” region where the activities are happening and divides the tiles based on dirty rectangle boundary. Then the tiles contain/cover “dirty rectangle” are marked as ROI tiles. The encoder can use more advanced search algorithms and more demanding rate-distortion decision process to encode the ROI (e.g. Tile 5).

To improve the processing efficiency, the processor can allocate computational resources based on the importance and size of the tiles. Dividing a picture into tiles based on its region information and assigning resources accordingly enhances the quality of important regions without stressing the encoder. The encoding latency can also be minimized by processing tiles in parallel. As described above, the dirty rectangle region with graphic updating is considered to be important regions. But this may not be the only criteria. The operating system could provide region information about the display to the encoder, e.g. the left side of the screen is a word document with some typing activity, while the right side is a YouTube video playing. Since there is typing going on, the encoder can assume the current ROI is the left side of the screen and perform the ROI encoding accordingly. The model to predict ROI based on dirty rectangle or region information could be trained through some machine learning techniques or designed empirically.

Tile prioritized transmission reduces end-to-end latency and improve Quality of Experience (QoE). A picture can be divided into multiple tiles based on its region update status and ROI and different encoding algorithms and processing resources can be applied to different tiles to improve quality and coding efficiency. At the same time, the encoded tiles can be assigned different priorities and transmitted under different transmission policies.

First, tiles containing ROI or updated content may be packetized into a separate NAL unit and transmitted first to guarantee a timely delivery. When the network bandwidth is limited, prioritizing ROI tiles may be effectively reduce the perceptual delay. For example, in FIG. 3, assume in frame n, the whole picture is refreshed with new content. Then for frames after that, only the grey area is constantly refreshed with new content. If the network bandwidth is limited, the encoder may choose to (1) send a high-quality frame n with large size, which results in a delayed reception at the receiver side; (2) drop some pictures for encoding, causing stuttering artifacts; (3) send low quality pictures and gradually improve the quality later. All these options can cause an unpleasant user experience with long response time, unsmooth motion or low quality image.

To improve QoE under this situation, the white and grey areas may be encoded in separate tiles and the grey-region tile may be prioritized for optimal quality and prompt delivery. Since the grey-region tile is only a small part of the picture, encoding it in full quality and prioritizing its transmission would not introduce additional latency under the bandwidth constraints. Ensuring the timely update and display of the grey region should improve the user QoE for the wireless display.

Meanwhile, the encoder can gradually improve the quality of the white area while extra bandwidth is available. Since the white area is unchanged after frame n, slowly updating its quality should not cause any motion-related artifacts and have less impact on the overall user experience.

Secondly, when network is prone to errors, the more important tiles can be duplicated on the transmission path to ensure an error-free delivery. Alternatively, only important tiles may be refreshed rather than the whole frame—an improvement over a full-frame intra refresh. Guaranteeing the display of important tiles helps to preserve critical display updates, thus, enhancing the user perception of the wireless display.

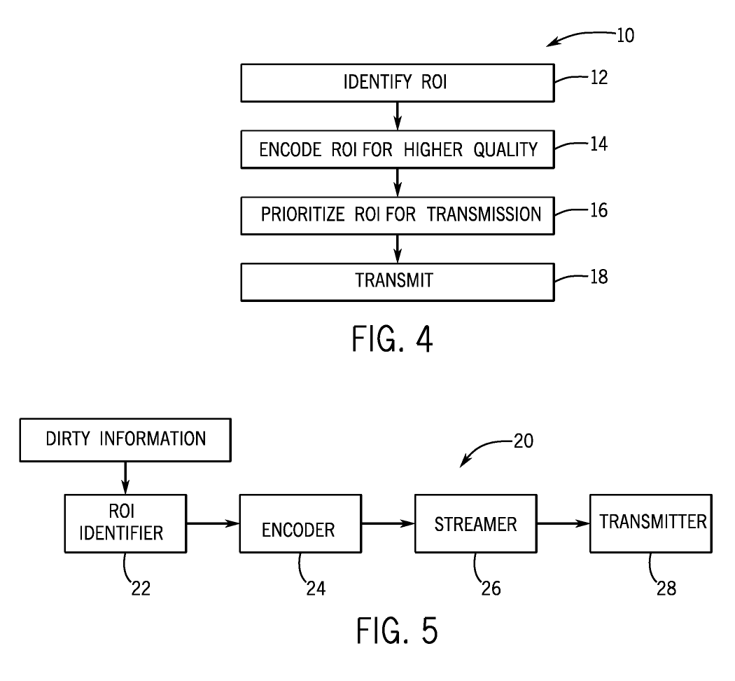

Referring to FIG. 4, a sequence 10 may be implemented in software, firmware and/or hardware. In software and firmware embodiments it may be implemented by computer executed instructions stored in one or more non-transitory computer readable media such as magnetic, optical or semiconductor storage.

The sequence 10 begins by identifying a region of interest (ROI) as indicated in block 12. The identification of the region of interest may be based in one embodiment on dirty rectangle information. Other techniques for identifying regions of interest may also be used.

Then the region of interest may be encoded for higher quality as indicated in block 14. For example, it may be encoded using more bits so that the region of interest includes more bits per unit of area and other regions of the picture.

Next, the region of interest may be given a higher priority for transmission relative to non-regions of interest so that upon decoding, if there are delays, the region of interest will appear on the display as indicated in block 16. Then the prioritized stream may be transmitted as indicated in block 18.

Thus in accordance with one embodiment shown in FIG. 5, an encoder transmitter 20 may include a region of interest identifier 22 that receives dirty rectangle information. The region of interest identifier may then be used by the encoder 24 to encode the region of interest with higher quality encoding compared to other regions. Then a streamer 26 forms a stream of encoded packets for transmission to the transmitter 28. The streamer may prioritize packets that include the region of interest relative to packets that include other tiles that are not the region of interest.

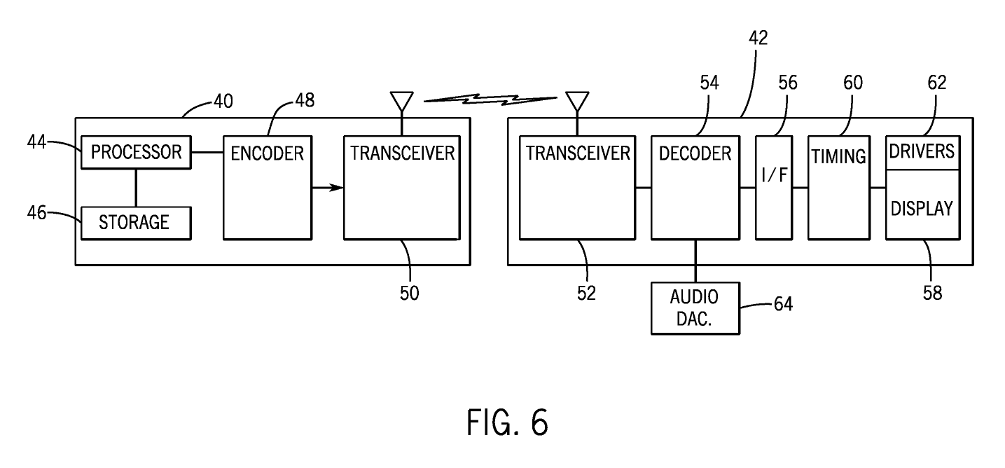

Referring to FIG. 6, a media source 40 may transmit audio and video data wirelessly to a video sink device 42. The transmission may be over any of a variety of wireless protocols including Worldwide Interoperability for Microwave Access (WiMax)(IEEE 802.16), mobile WiMax, IEEE 802.15, Bluetooth, IEEE 802.11, WiFi (IEEE 802.11x), Wireless Gigabit Alliance (WiGig) or cellular, such as 4G to mention some examples.

The media source 40 may include one or more processors 44 coupled to storage 46. Storage may be provided to store both software and media.

The processor 44 is coupled to an encoder 48. The encoder may encode both video and audio. For example the encoder may include an Motion Pictures Experts Group (ISO/IEC JTC11 SC29/G11)(MPEG-4) or H.264 video encoder in accordance with some embodiments. It may also include an audio encoder such as MPEG-2 audio, MPEG-4 audio, Audio Coding 3 (AC-3), Advanced Audiology (AAC), or Linear Predictive Coding (LPC) audio encoder (Standard ISO/IEC 14496).

The encoder couples the encoded media to the transceiver 50 which is responsible for transmitting over the appropriate wireless protocol to the wireless sink device 42 which may include an internal or external display 58.

The wireless sink device 42 includes a transceiver 52 for receiving and transmission from the source. The received information is provided to decoder 54. The decoder may decode the received information to one of variety decoded data formats. An interface 56 may be responsible for converting the received information which may be decoded in Transition Minimized Differential Signaling (TMDS) or High Definition Multimedia Interference (HDMI) for example to a format appropriate for the display 58, such as Low Voltage Differential Signaling (LVDS).

The decoder 54 also provides an audio output to an audio digital analog converter (DAC) 64.

The timing of the signal and particularly the video data may be adjusted using a timing controller or T-CON 60. Row and column drivers 62 may drive the display 58. The display may be any of a variety of formats including Liquid Crystal Display (LCD), Field Emission Display (FED), Plasma Display Panel (PDP), or Light Emitting Diode (LED) or Electronic Paper Display (EPD) to mention some examples.

The following clauses and/or examples pertain to further embodiments

One example embodiment may be a method comprising dividing an image into tiles, identifying at least one tile as a region of interest, encoding a tile including a region of interest with more bits than another tile in said image, and transmitting said image. The method may include packetizing said tiles. The method may include prioritizing packets for the tile including the region of interest for transmission before other tiles. The method may include defining said tiles as coding tree units. The method may include a plurality of coding tree units in a tile. The method may include aligning all boundaries of a tile with coding tree unit boundaries. The method may include processing coding tree units within a tile in rasterization order. The method may include processing tiles to break in picture prediction dependencies. The method may include packing a tile containing a region of interest into a separate network abstraction layer unit. The method may include transmitting said network abstraction layer unit before any other units of said image.

Another example embodiment may include one or more non-transitory computer readable media storing instructions to perform a sequence comprising dividing an image into tiles, identifying at least one tile as a region of interest, encoding a tile including a region of interest with more bits than another tile in said image, and transmitting said image. The media may further store instructions to perform a sequence including packetizing said tiles. The media may further store instructions to perform a sequence including prioritizing packets for the tile including the region of interest for transmission before other tiles. The media may further store instructions to perform a sequence including defining said tiles as coding tree units. The media may further store instructions to perform a sequence including a plurality of coding tree units in a tile. The media may further store instructions to perform a sequence including aligning all boundaries of a tile with coding tree unit boundaries. The media may further store instructions to perform a sequence including processing coding tree units within a tile in rasterization order. The media may further store instructions to perform a sequence including processing tiles to break in picture prediction dependencies. The media may further store instructions to perform a sequence including packing a tile containing a region of interest into a separate network abstraction layer unit. The media may further store instructions to perform a sequence including transmitting said network abstraction layer unit before any other units of said image.

In another example embodiment may be an apparatus comprising a processor to divide an image into tiles, identify at least one tile as a region of interest, encode a tile including a region of interest with more bits than another tile in said image, and transmit said image, and a memory coupled to said processor. The apparatus may include said processor to packetize said tiles. The apparatus may include said processor to prioritize packets for the tile including the region of interest for transmission before other tiles. The apparatus may include said processor to define said tiles as coding tree units. The apparatus may include said processor to include a plurality of coding tree units in a tile. The apparatus may include said processor to align all boundaries of a tile with coding tree unit boundaries. The apparatus may include said processor to process coding tree units within a tile in rasterization order. The apparatus may include said processor to process tiles to break in picture prediction dependencies. The apparatus may include said processor to pack a tile containing a region of interest into a separate network abstraction layer unit. The apparatus may include said processor to transmit said network abstraction layer unit before any other units of said image.

References throughout this specification to “one embodiment” or “an embodiment” mean that a particular feature, structure, or characteristic described in connection with the embodiment is included in at least one implementation encompassed within the present disclosure. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While a limited number of embodiments have been described, those skilled in the art will appreciate numerous modifications and variations therefrom. It is intended that the appended claims cover all such modifications and variations as fall within the true spirit and scope of this disclosure.

What is claimed is:

1. A method comprising:
dividing an image into tiles;
identifying at least one tile as a region of interest;
encoding a tile including a region of interest with more bits than another tile in said image; and
transmitting said image.

2. The method of claim 1 including packetizing said tiles.

3. The method of claim 1 including prioritizing packets for the tile including the region of interest for transmission before other tiles.

4. The method of claim 1 including defining said tiles as coding tree units.

5. The method of claim 4 including a plurality of coding tree units in a tile.

6. The method of claim 5 including aligning all boundaries of a tile with coding tree unit boundaries.

7. The method of claim 6 including processing coding tree units within a tile in rasterization order.

8. The method of claim 5 including processing tiles to break in picture prediction dependencies.

9. The method of claim 1 including packing a tile containing a region of interest into a separate network abstraction layer unit.

10. The method of claim 9 including transmitting said network abstraction layer unit before any other units of said image.

11. One or more non-transitory computer readable media storing instructions to perform a sequence comprising:
dividing an image into tiles;
identifying at least one tile as a region of interest;
encoding a tile including a region of interest with more bits than another tile in said image; and
transmitting said image.

12. The media of claim 11 further storing instructions to perform a sequence including packetizing said tiles.

13. The media of claim 11 further storing instructions to perform a sequence including prioritizing packets for the tile including the region of interest for transmission before other tiles.

14. The media of claim 11 further storing instructions to perform a sequence including defining said tiles as coding tree units.

15. The media of claim 14 further storing instructions to perform a sequence including a plurality of coding tree units in a tile.

16. The media of claim 15 further storing instructions to perform a sequence including aligning all boundaries of a tile with coding tree unit boundaries.

17. The media of claim 16 further storing instructions to perform a sequence including processing coding tree units within a tile in rasterization order.

18. The media of claim 15 further storing instructions to perform a sequence including processing tiles to break in picture prediction dependencies.

19. The media of claim 11 further storing instructions to perform a sequence including packing a tile containing a region of interest into a separate network abstraction layer unit.

20. The media of claim 19 further storing instructions to perform a sequence including transmitting said network abstraction layer unit before any other units of said image.

21. An apparatus comprising:
a processor to divide an image into tiles, identify at least one tile as a region of interest, encode a tile including a region of interest with more bits than another tile in said image, and transmit said image; and
a memory coupled to said processor.

22. The apparatus of claim 21, said processor to packetize said tiles.

23. The apparatus of claim 21, said processor to prioritize packets for the tile including the region of interest for transmission before other tiles.

24. The apparatus of claim 21, said processor to define said tiles as coding tree units.

25. The apparatus of claim 24, said processor to include a plurality of coding tree units in a tile.

26. The apparatus of claim 25, said processor to align all boundaries of a tile with coding tree unit boundaries.

27. The apparatus of claim 26, said processor to process coding tree units within a tile in rasterization order.

28. The apparatus of claim 25, said processor to process tiles to break in picture prediction dependencies.

29. The apparatus of claim 21, said processor to pack a tile containing a region of interest into a separate network abstraction layer unit.

30. The apparatus of claim 29, said processor to transmit said network abstraction layer unit before any other units of said image.
